(19) United States
(12) Patent Application Publication
(10) Pub. No.: US 2024/0344168 A1
(43) Pub. Date: Oct. 17, 2024

(54) METAL RECOVERY APPARATUS AND METAL RECOVERY METHOD

(71) Applicants: KYUSHU UNIVERSITY, NATIONAL UNIVERSITY CORPORATION, Fukuoka-shi, Fukuoka (JP); PRIME PLANET ENERGY & SOLUTIONS, INC., Tokyo (JP); TOYOTA TSUSHO CORPORATION, Nagoya-shi, Aichi (JP); TOYOTA JIDOSHA KABUSHIKI KAISHA, Toyota-shi, Aichi (JP)

(72) Inventors: Masahiro GOTO, Fukuoka-shi, Fukuoka (JP); Takafumi HANADA, Fukuoka-shi, Fukuoka (JP)

(21) Appl. No.: 18/294,199

(22) PCT Filed: Aug. 4, 2022
(86) PCT No.: PCT/JP2022/029877

§ 371 Date: Feb. 1, 2024

(30) Foreign Application Priority Data
Aug. 4, 2021 (JP) 2021-128042

(51) Int. Cl. C22B 3/02; C22B 3/00; C22B 3/16; C22B 3/20; C22B 11/00; C22B 26/12

(52) U.S. Cl. CPC C22B 3/02; C22B 3/165; C22B 3/205; C22B 11/04; C22B 23/0415; C22B 23/0453; C22B 26/12

(57) ABSTRACT

A metal recovery apparatus including a leaching unit that directly leaches a metal element contained in a composition into a hydrophobic deep eutectic solvent and a recovery unit that separates and recovers the metal element from the deep eutectic solvent, wherein the metal element-containing composition is solid at 25° C. and does not contain an inorganic acid, the metal element is a metal, a metal compound, or metal ions, and the deep eutectic solvent does not contain an inorganic acid.

### TECHNICAL FIELD

The present invention relates to a metal recovery apparatus and a metal recovery method.

### BACKGROUND ART

In order to utilize resources efficiently, there is a need for a metal recovery apparatus used in metal refining and recycling. For example, in recent years, with the spread of lithium ion batteries (LiB), there has been an increased demand for cobalt and nickel, which are rare metals used in positive electrode materials (positive electrode active materials). Due to uneven production of these metals and resource depletion issues, there is a need for rare metal recycling technology from waste LiB.

Conventionally, recycling was carried out using a pyrometallurgical method; however, due to problems such as energy consumption and lack of purity, a hydrometallurgical method is being developed. The hydrometallurgical method is a process in which a positive electrode material is leached into a solution using an acid or the like, and target metals are then individually recovered using solvent extraction or a precipitation method. The oxidation number of Co in LiCoO₂, a typical positive electrode material, is +3, and since the oxide is stable, it is difficult to dissolve into an aqueous solution. Therefore, although a leaching method is known in which Co(II) is produced and efficiently leached into an aqueous phase by using a reducing agent together with an inorganic acid, there are concerns that the method may cause environmental pollution due to a large amount of acid wastewater.

In contrast, deep eutectic solvents (DES) and ionic liquids are attracting attention as environmentally friendly leaching media (see, for example, Patent Literatures 1 and 2).

PTL 1 describes an ionic compound with a freezing point of up to 100° C. formed by reacting at least one amine salt represented by a specific structure with at least one organic compound (II) capable of forming a hydrogen bond with a specific anion. In [0055] of PTL 1, it is described that among such ionic liquids, a 2:1 urea-choline chloride ionic liquid can be used to extract metal oxides from ores, and such metals can be extracted from the ionic liquids using electrowinning. Further, in [0058] to [0060] of PTL 1, it is described that such an ionic liquid of carboxylic acid (oxalic acid)-choline chloride can be recovered from materials and substances containing noble metals, especially platinum and palladium, as oxides, and Pd can be recovered from a samples of automobile catalyst containing PdO supported on an alumina carrier.

PTL 2 describes a rare earth extractant containing a diketone and a neutral extractant, and also describes that the rare earth extractant can selectively extract rare earth elements even in a low pH region. PTL 2 specifically describes a rare earth extractant containing a diketone (2-thenoyltrifluoroacetone; melting point of 40 to 44° C.) and a neutral extractant (trioctylphosphine oxide; TOPO), and suggests in [0030] that the rare earth extractant is a liquid at room temperature.

### CITATION LIST

### Patent Literature

PTL 1: JP 2004509945 A
PTL 2: JP 2015057505 A

### SUMMARY OF INVENTION

### Technical Problem

However, the method described in PTL 1 uses a hydrophilic ionic liquid or deep eutectic solvent using hydrophilic urea or oxalic acid, and after a metal component is leached into the ionic liquid phase or deep eutectic solvent phase, it is necessary to bring the metal component into contact with an organic solvent to extract the metal component into the organic phase, and then to contact the metal component with a hydrophilic solvent for recovery. Further improvements were required in order to achieve an environmentally friendly metal recovery method in terms of extraction using organic solvents.

The method described in PTL 2 involves leaching metal components from a metal element-containing composition with acid, and then applying a rare earth extractant to an acidic solution from which the metal components have been leached. Therefore, the metal components of the solid metal element-containing composition are not directly leached into a hydrophobic deep eutectic solvent that does not contain an inorganic acid, and in view of the fact that acid waste liquid is generated, further improvements were required in order to create an environmentally friendly metal recovery method. In addition, as the rare earth extractant, a diketone and a neutral extractant dissolved in an organic solvent diluent (toluene) are used, and in fact, a certain amount of organic solvent is used for extraction. In view of the fact, further improvements were required to create an environmentally friendly metal recovery method.

A problem to be solved by the present invention is to provide an environmentally friendly metal recovery apparatus that does not perform leaching with a highly concentrated inorganic acid or extraction with an organic solvent.

### Solution to Problem

As a result of extensive studies, the present inventors have found that the problem of acid waste liquid could be solved by bringing, instead of the acid used in a conventional leaching method using an inorganic acid, a deep eutectic solvent into direct contact with a solid metal element-containing composition, and by using a hydrophobic deep eutectic solvent, metals could be recovered by being contacted with a hydrophilic solvent without extraction with an organic solvent, and have solved the above problem. Configurations of the present invention, which are specific measures for solving the above problem, and preferred configurations of the present invention will be described below.

[1] A metal recovery apparatus including
a leaching unit that directly leaches at least one metal component contained in a metal element-containing composition into a hydrophobic deep eutectic solvent, and
a recovery unit that separates and recovers the metal component from the deep eutectic solvent, wherein
the metal element-containing composition is solid at 25° C. and does not contain an inorganic acid,
the metal component is a metal, a metal compound, or metal ions, and
the deep eutectic solvent does not contain an inorganic acid.

[2] The metal recovery apparatus according to [1], wherein the deep eutectic solvent has hydrophobicity of 1 g/100 mL or less in terms of solubility in water at 25° C.

[3] The metal recovery apparatus according to [1] or [2], wherein the deep eutectic solvent does not contain an organic solvent having a boiling point of 150° C. or lower alone.

[4] The metal recovery apparatus according to any one of [1] to [3], wherein extraction of moving the metal component from the deep eutectic solvent to another organic solvent is not performed between the leaching unit and the recovery unit.

[5] The metal recovery apparatus according to any one of [1] to [4], wherein the deep eutectic solvent is a liquid at 25° C.

[6] The metal recovery apparatus according to any one of [1] to [5], wherein the metal element-containing composition contains two or more types of the metal components,
the deep eutectic solvent selectively leaches a specific type of metal component among the two or more types of metal components at a higher concentration than other types of metal components.

[7] The metal recovery apparatus according to any one of [I] to [6], wherein the deep eutectic solvent is a mixture of a hydrogen bond donor and a hydrogen bond acceptor,
at 25° C., the hydrogen bond donor and the hydrogen bond acceptor before mixing are in a form of solid particles,
the metal component is brought into contact with the deep eutectic solvent by directly contacting the solid particulate hydrogen bond donor and hydrogen bond acceptor with the metal element-containing composition.

[8] The metal recovery apparatus according to any one of [1] to [7], wherein the deep eutectic solvent is a mixture of a hydrogen bond donor and a hydrogen bond acceptor,
the hydrogen bond donor is benzoyltrifluoroacetone or a decanoic acid, and
the hydrogen bond acceptor is tri-n-octylphosphine oxide.

[9] The metal recovery apparatus according to any one of [I] to [8], wherein the deep eutectic solvent is a mixture of a hydrogen bond donor and a hydrogen bond acceptor,
the hydrogen bond donor has a concentration controlled to be 1.2 to 5 times the concentration of the hydrogen bond acceptor.

[10] The metal recovery apparatus according to any one of [1] to [9], wherein the metal element-containing composition contains a metal oxide, and
a reducing agent is further added to the deep eutectic solvent.

[11] The metal recovery apparatus according to [10], wherein the reducing agent is an L-ascorbic acid, a citric acid, or a malic acid.

[12] The metal recovery apparatus according to [10] or [11], wherein the reducing agent has a concentration controlled to 0.03 to 0.30 mol/L with respect to the deep eutectic solvent.

[13] The metal recovery apparatus according to any one of [10] to [12], wherein the metal element-containing composition contains LiCoO₂ or LiNi_{1/3}Mn_{1/3}Co_{1/3}O₂.

[14] The metal recovery apparatus according to any one of [1] to [9], wherein the metal element-containing composition contains a platinum group metal or a platinum group metal compound, and an oxidizing agent is further added to the deep eutectic solvent.

[15] The metal recovery apparatus according to any one of [1] to [14], wherein the deep eutectic solvent has a water content controlled to 0.3 to 2.8% by mass.

[16] The metal recovery apparatus according to any one of [1] to [15], wherein the recovery unit brings a hydrophilic solvent into contact with the deep eutectic solvent to separate and recover the metal component in the hydrophilic solvent.

[17] The metal recovery apparatus according to [16], wherein a chelating agent is added to the hydrophilic solvent, and the metal component is precipitated as a salt in the hydrophilic solvent to be separated and recovered.

[18] The metal recovery apparatus according to any one of [1] to [17], further including a recycle unit that returns the deep eutectic solvent from which the metal component has been separated in the recovery unit to the leaching unit to recycle.

[19] The metal recovery apparatus according to [18], wherein the recycle unit cleans the deep eutectic solvent using a cleaning liquid that is capable of removing the chelating agent.

[20] The metal recovery apparatus according to [18] or [19], wherein, when a cycle of the leaching unit, the recovery unit, and the recycle unit is repeated three times using only the deep eutectic solvent returned by the recycle unit in the leaching unit, the metal component has a leaching rate expressed by the following formula 1 of 80% or more, and the metal component has a recovery rate expressed by the following formula 2 of 95% or more,

$$\% L = \frac{{C}_{M , DES} \times {V}_{DES}}{\frac{{m}_{init}}{m}} \times 100 \qquad Formula 1$$

in the formula 1. % L represents the leaching rate, C_{M,DES} represents a concentration of the metal component in the deep eutectic solvent, V_{DES} represents a volume of the deep eutectic solvent, mᵢₙᵢₜ represents a mass of the metal element-containing composition, and m represents a molecular weight of the metal element-containing composition,

$$\% S = \frac{{C}_{M , S , DES} \times {V}_{S , DES}}{{C}_{M , L , DES} \times {V}_{L , DES}} \times 100 \qquad Formula 2$$

in the formula 2, % S represents the recovery rate, C_{M,DES} represents the concentration of the metal component in the deep eutectic solvent in a recovery step, V_{S,DES} represents the volume of the deep eutectic solvent in the recovery step, C_{M,I,DES} represents the concentration of the metal component in the deep eutectic solvent in a leaching step, and V_{L,DES} represents the volume of the deep eutectic solvent in the leaching step.

[21] A metal recovery method, including
directly leaching at least one metal component contained in a metal element-containing composition into a hydrophobic deep eutectic solvent, and
separating and recovering the metal component from the deep eutectic solvent, wherein
the metal element-containing composition is solid at 25° C. and does not contain an inorganic acid,
the metal component is a metal, a metal compound, or metal ions, and
the deep eutectic solvent does not contain an inorganic acid.

### Advantageous Effects of Invention

According to the present invention, it is possible to provide an environmentally friendly metal recovery apparatus that does not perform leaching with a highly concentrated inorganic acid or extraction with an organic solvent.

### BRIEF DESCRIPTION OF DRAWINGS

FIG. 1 is a schematic diagram of an example of a metal recovery apparatus of the present invention.

FIG. 2 is a schematic diagram of a metal recovery apparatus using a hydrophilic deep eutectic solvent.

FIG. 3 is a schematic diagram of a metal recovery apparatus using a leaching method using an inorganic acid.

FIG. 4 is a bar graph showing leaching rates of Li and Co in metal recovery methods of Examples 1 to 8.

FIG. 5 is a bar graph showing the leaching rates of Li and Co in the metal recovery methods of Examples 11 to 14.

FIG. 6 is a bar graph showing the leaching rates of Li and Co in the metal recovery methods of Examples 21 to 24.

FIG. 7 is a stacked bar graph showing abundance ratios of Li and Co in a deep eutectic solvent (DES) phase, an aqueous phase, and precipitate in the metal recovery methods of Examples 31 to 33.

FIG. 8 is a bar graph showing the leaching rate % L and recovery rate % S of Li and Co in each cycle in the metal recovery method of Example 41.

FIG. 9 is a bar graph showing the leaching rate % L and recovery rate % S of Li, Mn, Co, and Ni in the metal recovery methods of Examples 51 and 52.

FIG. 10 is an electron micrograph of a positive electrode material before leaching, a positive electrode material after leaching of Example 52, and a positive electrode material after leaching of Comparative Example 53, observed with a scanning electron microscope equipped with an X-ray spectrometer (SEM-EDS).

FIG. 11 is an EDS chart obtained by performing elemental analysis using an energy dispersive X-ray spectrometer (EDS) on the positive electrode material before leaching.

FIG. 12 is an EDS chart obtained by performing elemental analysis using an energy dispersive X-ray spectrometer on the positive electrode material after leaching of Example 52.

FIG. 13 is an EDS chart obtained by performing elemental analysis using energy dispersive X-ray spectroscopy on the positive electrode material after leaching of Comparative Example 53.

FIG. 14 is a schematic diagram of another example of the metal recovery apparatus of the present invention.

### DESCRIPTION OF EMBODIMENTS

The present invention will be explained in detail below. Although the constituent elements described below may be explained based on typical embodiments and specific examples, the present invention is not limited to such embodiments. In the present specification, a numerical range expressed using “X to Y” means a range that includes the numerical values X and Y written before and after the “to” as lower and upper limits.

### [Metal Recovery Apparatus]

The metal recovery apparatus of the present invention includes
a leaching unit that directly leaches at least one metal component contained in a metal element-containing composition into a hydrophobic deep eutectic solvent, and
a recovery unit that separates and recovers the metal component from the deep eutectic solvent, wherein
the metal element-containing composition is solid at 25° C. and does not contain an inorganic acid,
the metal component is a metal, a metal compound, or metal ions, and
the deep eutectic solvent does not contain an inorganic acid.

With this configuration, it is possible to provide an environmentally friendly metal recovery apparatus that does not perform leaching with a highly concentrated inorganic acid or extraction with an organic solvent.

Hereinafter, preferred embodiments of the present invention will be explained.

### <Metal Recovery Method>

Preferred embodiments of the metal recovery apparatus of the present invention will be described with reference to the drawings, together with the metal recovery method of the present invention.

Here, the metal recovery method of the present invention includes a leaching step of directly leaching at least one metal component contained in a metal element-containing composition into a hydrophobic deep eutectic solvent, and a recovery step of separating and recovering the metal component from the deep eutectic solvent, wherein the metal element-containing composition is solid at 25° C. and does not contain an inorganic acid, the metal component is a metal, a metal compound, or metal ions, and the deep eutectic solvent does not contain an inorganic acid. Preferred embodiments of the metal recovery method of the present invention are the same as preferred embodiments of the metal recovery apparatus of the present invention.

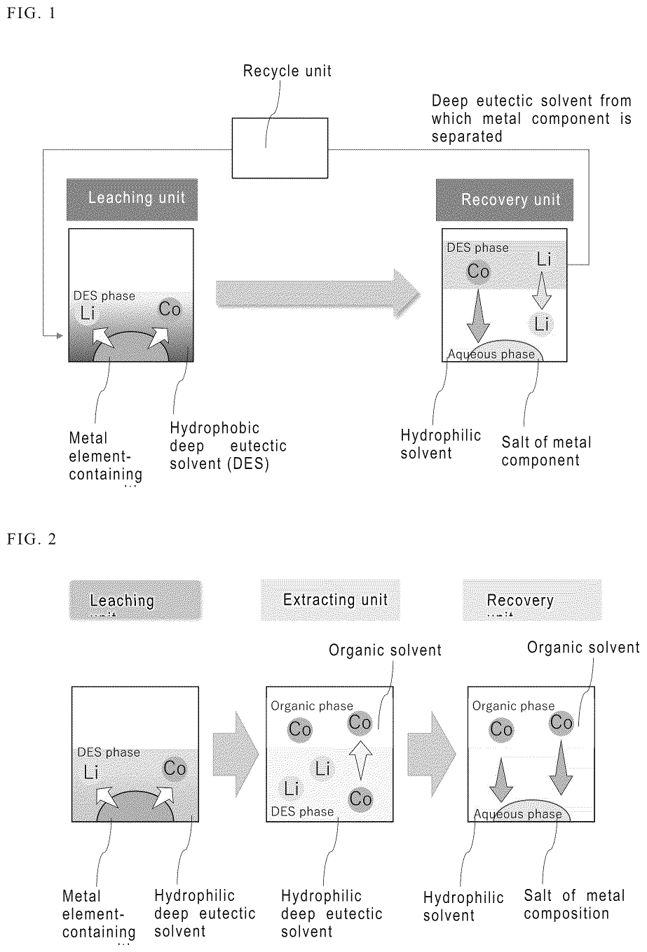

FIG. 1 is a schematic diagram of an example of the metal recovery apparatus of the present invention.

The metal recovery apparatus shown in FIG. 1 includes a leaching unit that directly leaches at least one metal component contained in a metal element-containing composition into a hydrophobic deep eutectic solvent, and a recovery unit that separates and recovers the metal component from the deep eutectic solvent.

First, metal components (Li, Co) are leached from the metal element-containing composition using a hydrophobic deep eutectic solvent, and target metal components are dissolved (leached) into the hydrophobic deep eutectic solvent (DES phase).

Subsequently, in the recovery unit, by bringing the hydrophobic deep eutectic solvent into which the metal components have leached into contact with a hydrophilic solvent (aqueous phase), the target metal components (Li, Co) are completely recovered from the hydrophobic deep eutectic solvent into the hydrophilic solvent. As shown in FIG. 1, some types of target metal components (Co) can be recovered as precipitates, which are salts of the metal components, and other types of metal components (Li) can be recovered as metal ions in a hydrophilic solvent.

The metal recovery apparatus shown in FIG. 1 further moves the deep eutectic solvent from which the metal components have been separated to a recycle unit, and then recycles the deep eutectic solvent in the leaching unit. However, the recycle unit is not an essential component in the metal recovery apparatus of the present invention.

It is preferable that the metal recovery apparatus does not perform an extraction step that moves the metal component from the deep eutectic solvent to another organic solvent between the leaching unit and the recovery unit. The use of a hydrophobic deep eutectic solvent has an effect of serving as a solvent for both the leaching step and the recovery step without performing an extraction step.

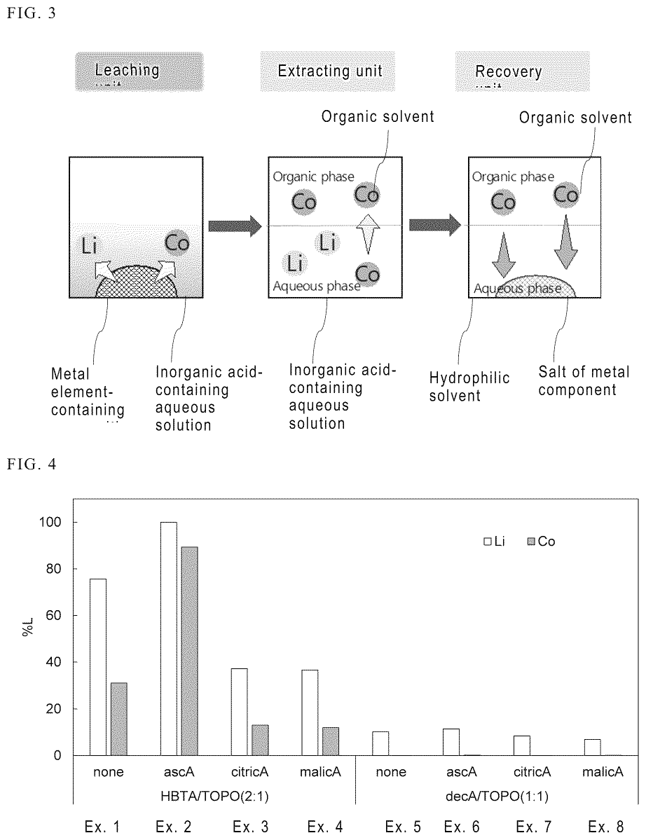

Here, an example of a metal recovery apparatus using a conventional hydrometallurgical method is shown in FIGS. 2 and 3. FIG. 2 is a schematic diagram of a metal recovery apparatus using a hydrophilic deep eutectic solvent. The metal recovery apparatus shown in FIG. 2 includes a leaching unit that directly leaches a metal component contained in a metal element-containing composition into a hydrophilic deep eutectic solvent, an extracting unit that moves the metal component from the hydrophilic deep eutectic solvent to another organic solvent (organic phase), and a recovery unit that moves the metal component from the organic solvent to a hydrophilic solvent and separates and recovers the metal component.

FIG. 3 is a schematic diagram of a metal recovery apparatus using a leaching method using an inorganic acid. The metal recovery apparatus shown in FIG. 3 includes a leaching unit that leaches a metal component contained in a metal element-containing composition into an inorganic acid-containing aqueous solution (aqueous phase), an extracting unit that moves one type of metal component (Co) from the inorganic acid-containing aqueous solution to an organic solvent (organic phase) to separate the metal component, and a recovery unit that moves the metal component (Co) from the organic solvent to a hydrophilic solvent and separates and recovers the metal component. Currently, the metal recovery apparatus shown in FIG. 3 is applied to recycling of home appliances, and the metal recovery apparatus pulverizes a metal element-containing composition into powder, dissolves as many types of metals as possible in an aqueous solution containing an inorganic acid, and moves the metals to an organic solvent containing an extractant, a compound that can selectively extract rare metals such as Co. In the metal recovery apparatus shown in FIG. 3, selective leaching of metal components is difficult.

### <Leaching Unit>

In the leaching unit, at least one metal component contained in the metal element-containing composition is directly leached into a hydrophobic deep eutectic solvent.

Furthermore, it is preferable that the leaching unit has high leaching efficiency. The leaching rate of the metal component is preferably 10% or more, more preferably 20% or more, particularly preferably 50% or more, more particularly preferably 70% or more, and even more particularly preferably 80% or more.

It is preferable that the leaching unit has high selectivity of metal components. In particular, it is preferable that only rare metals such as Co, Ni, and platinum group elements be selectively leached. On the other hand, it is preferable that the leaching rate of Fe, Al, Si, Ti, etc. is low in the leaching unit. The selectivity of metal components in the leaching unit can be controlled by the type and mixing ratio of the deep eutectic solvent, and the type and amount of the reducing agent or oxidizing agent.

### (Metal Element-Containing Composition)

In the present invention, the metal element-containing composition contains at least one metal component, is solid at 25° C., and does not contain an inorganic acid.

By using a metal element-containing composition that is solid at 25° C., there is no need to dissolve the metal element-containing composition in a solvent, a dispersion medium, an inorganic acid, etc. before the recovery step in the recovery unit, and there is no need to adjust the pH, making it possible to provide an environmentally friendly metal recovery apparatus.

In addition, by using a deep eutectic solvent that does not contain an inorganic acid in this way, an environnmentally friendly metal recovery apparatus can be provided. Examples of the inorganic acid include hydrochloric acid, sulfuric acid, nitric acid, and aqua regia.

In the present invention, the metal component contained in the metal element-containing composition is a metal, a metal compound, or metal ions.

The type of the metal element-containing composition is not particularly limited. For example, the metal element-containing composition may contain a metal compound such as a metal oxide, or may contain a metal, but preferably contains a metal oxide.

When the metal element-containing composition contains a metal, it preferably contains an alkali metal, an alkaline earth metal, or a transition metal, and more preferably contains an alkali metal or a transition metal.

Among the alkali metals, it is preferable to contain Li from the viewpoint of recycling batteries such as lithium ion batteries.

Of the transition metals, it is more preferable to contain a first transition element (3d transition element), a second transition element (4d transition element), or a third transition element, and it is particularly preferable to contain a second transition element or a third transition element. Of the first transition elements, it is preferable to contain Mn, Co, and Ni. Of the second transition elements and the third transition elements, it is more preferable to contain a platinum group metal.

When the metal element-containing composition contains a metal compound or metal ions, the preferred types of metal components are the same as in the case of metals.

The metal recovery apparatus of the present invention is useful for separating rare metals and recycling batteries. When the metal recovery apparatus of the present invention is used for recycling batteries such as lithium ion batteries, the metal element-containing composition preferably contains a metal oxide, more preferably contains a metal oxide containing the Li element, and particularly preferably contains LiCoO₂ or LiNi_{1/3}Mn_{1/3}Co_{1/3}O₂, which are often used as positive electrode materials for lithium ion batteries. When the metal recovery apparatus of the present invention is used to recycle rare metals from automobile exhaust gas catalysts, it is preferable to contain metals such as platinum, palladium, and rhodium, or metal compounds thereof, more preferable to contain a platinum group metal or a platinum group metal compound, and particularly preferable to contain a platinum group metal. When the metal recovery apparatus of the present invention is used to recycle rare metals from ores, it is preferable to contain metals such as Ni and Co, and metal compounds thereof (particularly metal oxides).

### (Deep Eutectic Solvent)

In the present invention, a hydrophobic deep eutectic solvent is used as the deep eutectic solvent.

A deep eutectic solvent refers to a material that is prepared as a liquid at 25° C. by lowering the melting point by mixing two or more types of compounds. The deep eutectic solvent preferably has excellent properties such as low volatility, flame retardancy, and good design. Deep eutectic solvents exhibit excellent performance in dissolving metal oxides due to their unique metal coordination ability and acidity.

The number of compounds used to prepare the deep eutectic solvent may be two or more, for example, three to five.

A hydrophobic deep eutectic solvent refers to a deep eutectic solvent that is immiscible with water. The hydrophobicity of the deep eutectic solvent is preferably 1 g/100 mL or less, more preferably 0.1 g/100 mL or less, and particularly preferably 0.01 g/100 mL or less as a solubility in water at 25° C.

When the metal element-containing composition contains two or more types of metal components, the deep eutectic solvent preferably selectively leaches a particular type of metal component out of the two or more types of metal components at a higher concentration than that of the other types of metal components.

The deep eutectic solvent is preferably prepared by mixing two or more types of hydrogen-bonding compounds. That is, it is preferable that the deep eutectic solvent is a mixture of a hydrogen bond donor (HBD) and a hydrogen bond acceptor (HBA).

The hydrogen bond donor may be a compound having a hydroxy group such as alcohol, a compound having a carboxy group, etc., and it is preferably a compound having a metal coordinating functional group. Examples of the hydrogen bond donor include a fatty acid, urea, glucose, glycerol, benzoyltrifluoroacetone (HBTA), and decanoic acid (decA). Of these, hydrophobic hydrogen bond donors such as octylphenol, diphenyl phosphate, fatty acid amine, fatty acid amide, long-chain alkylbenzenesulfonic acid, fatty acid, benzoyltrifluoroacetone (HBTA), and decanoic acid (decA) are preferred. In the present invention, it is preferable that the hydrogen bond donor is benzoyltrifluoroacetone or decanoic acid from the viewpoint of increasing leaching efficiency.

Examples of the hydrogen bond acceptor include amine-based compounds, and compounds with lone pairs of electrons such as choline chloride, ethers, ketones, and amides. Of these, hydrophobic hydrogen bond acceptors such as tetraoctylammonium chloride, tetrabutylphosphonium chloride, trioctylamine, diphenyl sulfoxide, diphenylamine, stearylamine, triphenyl phosphate, betaine and tetrabutylammonium bromide, and tri-n-octylphosphine oxide (TOPO) are preferred. In the present invention, it is preferable that the hydrogen bond acceptor is tri-n-octylphosphine oxide from the viewpoint of increasing leaching efficiency.

The ratio of the concentration of the hydrogen bond donor to the concentration of the hydrogen bond acceptor is not particularly limited; for example, the concentration of the hydrogen bond donor may be 0.1 to 10 times the concentration of the hydrogen bond acceptor. In the present invention, it is preferable to control the concentration of the hydrogen bond donor to 1.2 to 5 times the concentration of the hydrogen bond acceptor, from the viewpoint of easy leaching of metal components at lower pH, more preferable to control the concentration of the hydrogen bond donor to 1.5 to 3 times the concentration of the hydrogen bond acceptor, and particularly preferably to control the concentration of the hydrogen bond donor to 2 to 2.5 times the concentration of the hydrogen bond acceptor.

The deep eutectic solvent may contain components other than the hydrogen bond donor and the hydrogen bond acceptor. Examples of the other components that the deep eutectic solvent may contain include water, a reducing agent, and an oxidizing agent.

### —Water Content of Deep Eutectic Solvent—

In the present invention, the water content of the deep eutectic solvent is preferably controlled to 0.2% by mass or more, more preferably to 0.3 to 2.8% by mass from the viewpoint of increasing leaching efficiency, and particularly preferable to 1.0 to 2.5% by mass.

### —Reducing Agent—

When the metal element-containing composition contains a metal oxide, it is preferable to further add a reducing agent to the deep eutectic solvent.

The type of the reducing agent is not particularly limited, and any known reducing agent can be used. The reducing agent can be selected according to the required reducing power depending on the type of the metal element-containing composition. In the present invention, it is preferable that the reducing agent is capable of coordinating to a metal. Specifically, the reducing agent preferably has two or more hydroxy groups in the molecule, particularly preferably has three or more hydroxy groups in the molecule, and more particularly preferably has four or more hydroxy groups in the molecule. The reducing agent that is capable of coordinating to a metal is preferably L-ascorbic acid, citric acid or malic acid, and more preferably L-ascorbic acid from the viewpoint of increasing leaching efficiency.

The reducing agent may be used alone or in combination of two or more kinds thereof.

The concentration of the reducing agent is not particularly limited. In the present invention, from the viewpoint of increasing leaching efficiency, it is preferable to control the reducing agent to 0.03 to 0.30 mol/L, more preferably 0.06 to 0.25 mol/L, particularly preferably 0.07 to 1.9 mol/L, and more particularly preferably 1.1 to 1.8 mol/L, with respect to the deep eutectic solvent.

### —Oxidizing Agent—

When the metal element-containing composition contains a platinum group metal or a platinum group metal compound, it is preferable to further add an oxidizing agent to the deep eutectic solvent.

The type of the oxidizing agent is not particularly limited, and any known oxidizing agent can be used. The oxidizing agent can be selected according to the required oxidizing power depending on the type of the metal element-containing composition.

The oxidizing agent may be used alone or in combination of two or more kinds thereof.

It is preferable that the hydrogen bond donor and the hydrogen bond acceptor are in the form of solid particles before mixing at 25° C.

From the viewpoint of reducing the process of preparing a deep eutectic solvent, it is preferable that the metal component is brought into contact with the deep eutectic solvent by directly contacting the solid particulate hydrogen bond donor and hydrogen bond acceptor to the metal-containing composition.

Although not a deep eutectic solvent, room-temperature ionic liquids are known as media with similar functions. Ionic liquids are also called ion liquids, low melting point molten salts, etc. An ionic liquid refers to a salt that exists in a liquid form. A room-temperature ionic liquid refers to an ionic liquid that is in a liquid state at 25° C. and 1 atmosphere. An ionic liquid is mainly composed of one compound and has a positive or negative charge when ionized. Although an ionic liquid and another organic solvent are sometimes used in combination, the combination of an ionic liquid and another organic solvent is not such that the two are bonded together through a hydrogen bond.

By using a hydrophobic deep eutectic solvent, the leaching efficiency and recovery efficiency are higher than when using an ionic liquid. A general single ionic liquid has little power to leach metal components, and it is necessary to use the ionic liquid in combination with a reducing agent. Moreover, ionic liquids are expensive and difficult to use industrially. As the hydrophobic deep eutectic solvent, a combination of a hydrogen bond donor and a hydrogen bond acceptor that has been used industrially (in combination with an organic solvent) can be used, and it is easy to industrialize at low cost.

In the present invention, the deep eutectic solvent does not contain an inorganic acid. By using a deep eutectic solvent that does not contain an inorganic acid in this way, an environmentally friendly metal recovery apparatus can be provided. Examples of the inorganic acid include hydrochloric acid, sulfuric acid, nitric acid, and aqua regia.

It is preferable that the deep eutectic solvent does not contain an organic solvent having a boiling point of 150° C. or lower alone, from the viewpoint of providing an environmentally friendly metal recovery apparatus. The organic solvent contained in the deep eutectic solvent and having a boiling point of 150° C. or lower is preferably 5% by mass or less, more preferably 1% by mass or less, and particularly preferably 0.1% by mass or less.

### (Leaching Step)

The leaching temperature in the leaching unit is preferably 40° C. or higher, more preferably 50° C. or higher from the viewpoint of increasing the leaching rate, and particularly preferably 60° C. or higher. The temperature of the leaching step in the leaching unit is preferably 100° C. or lower from the viewpoint of energy efficiency, more preferably 80° C. or lower, and particularly preferably 70° C. or lower.

### <Recovery Unit>

In the recovery unit, the metal component is separated and recovered from the deep eutectic solvent.

In the recovery unit, it is preferable that the deep eutectic solvent is brought into contact with a hydrophilic solvent to separate and recover the metal component in the hydrophilic solvent.

Furthermore, it is preferable that the recovery efficiency is high in the recovery unit. The recovery rate of the metal component is particularly preferably 80% or more, more particularly preferably 90% or more, and even more particularly preferably 95% or more.

### (Hydrophilic Solvent)

The hydrophilic solvent used in the recovery unit is not particularly limited, and any known hydrophilic solvent can be used. Examples thereof include water and alcohols.

### (Chelating Agent, Precipitating Agent)

In the present invention, it is preferable to add a chelating agent or a precipitating agent to precipitate a poorly soluble salt into the hydrophilic solvent, and precipitate the metal component as a salt in the hydrophilic solvent to separate and recover the metal component. It is preferable to add a chelating agent to the hydrophilic solvent from the viewpoint of improving the reusability of the deep eutectic solvent. The chelating agent is not particularly limited, and any known chelating agent can be used. Examples of the chelating agent include oxalic acid and dimethylglyoxime, and it is more preferable to use oxalic acid. The precipitating agent for precipitating the poorly soluble salt is not particularly limited, and any known precipitating agent such as acids, alkalis, and salts can be used. It is more preferable to use sodium hydroxide, sodium carbonate, or sodium phosphate as the precipitating agent.

The concentration of the chelating agent or the precipitating agent is preferably 0.1 mol/L or more, more preferably 0.3 mol/L or more, and particularly preferably 0.5 mol/L or more.

### (Recovery Step)

The metal recovery apparatus only needs to be capable of separating and recovering metal components, that is, of separating and recovering at least one type of metal component. For example, when the metal element-containing composition contains three or more types of metal components, it is sufficient that one type of metal component can be separated and recovered, preferably two types of metal components can be separated and recovered respectively, and more preferably three types of metal components can be separated and recovered respectively.

On the other hand, one type of metal component may be separated as ions into an aqueous phase and recovered, and a mixed salt of two or more types of metal components may be separated and recovered as a precipitate. The mixed salt of two or more types of metal components may be further separated and recovered one by one by a known method.

After recovering the initially formed precipitate, it is preferable to further precipitate and recover the metal component separated as ions in the aqueous phase as a metal salt by a known method. For example, when the metal component separated as ions in the aqueous phase forms a carbonate with low solubility, the metal component separated as ions in the aqueous phase can be precipitated and recovered as a carbonate by blowing carbon dioxide gas into the aqueous phase.

### <Recycle Unit>

Preferably, the metal recovery apparatus of the present invention includes a recycle unit that returns the deep eutectic solvent from which the metal component has been separated in the recovery unit to the leaching unit to recycle.

### (Cleaning Liquid)

In the present invention, it is preferable that the recycle unit cleans the deep eutectic solvent using a cleaning liquid that is capable of removing the chelating agent, from the viewpoint of regenerating the deep eutectic solvent to achieve a high leaching rate, a high recovery rate, and a high reusability. The cleaning liquid is not particularly limited, and any known cleaning liquid can be used. Examples of the cleaning liquid include ammonia water and pure water.

The concentration of the ammonia water is not particularly limited, and can be set to, for example, 0.5 to 2 mol dm⁻³.

when a cycle of the leaching unit, the recovery unit, and the recycle unit is repeated three times using only the deep eutectic solvent returned by the recycle unit in the leaching unit, it is preferable that the leaching rate of the metal component expressed by the following formula 1 is 80% or more and the recovery rate of the metal component expressed by the following formula 2 is 95% or more; it is more preferable that the leaching rate is 90% or more and the recovery rate is 97% or more; and it is particularly preferable that the leaching rate is 99% or more and the recovery rate is 99% or more.

$$\% L = \frac{{C}_{M , DES} \times {V}_{DES}}{\frac{{m}_{init}}{m}} \times 100 \qquad Formula 1$$

In the formula 1, % L represents the leaching rate, C_{M,DES} represents the concentration of the metal component in the deep eutectic solvent, V_{DES} represents the volume of the deep eutectic solvent, mᵢₙᵢₜ, represents the mass of the metal element-containing composition, and m represents the molecular weight of the metal element-containing composition.

$$\% S = \frac{{C}_{M , S , DES} \times {V}_{S , DES}}{{C}_{M , L , DES} \times {V}_{L , DES}} \times 100 \qquad Formula 2$$

In the formula 2, % S represents the recovery rate, C_{M,DES} represents the concentration of the metal component in the deep eutectic solvent in the recovery step, V_{S,DES} represents the volume of the deep eutectic solvent in the recovery step, C_{M,L,DES} represents the concentration of the metal component in the deep eutectic solvent in the leaching step, and V_{L,DES} represents the volume of the deep eutectic solvent in the leaching step.

When using the deep eutectic solvent returned by the recycle unit in the leaching unit, an additive such as a reducing agent and an oxidizing agent that is different from that in the previous cycle may be added in the recycle unit or the leaching unit.

### <Washing Unit>

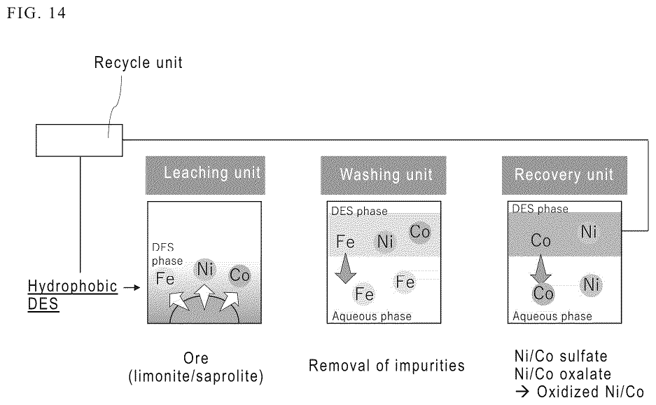

The metal recovery apparatus may be equipped with other functions or devices. For example, as shown in the schematic diagram of another example of the metal recovery apparatus of the present invention shown in FIG. 14, a washing unit may be provided between the leaching unit and the recovery unit.

The washing unit removes impurities and unnecessary metal components contained in the hydrophobic deep eutectic solvent obtained in the leaching unit, and does not perform an extraction step because the metal component to be recovered is not moved from the hydrophobic deep eutectic solvent phase.

### EXAMPLES

The present invention will be described in more detail below by reference to Examples and Comparative Examples. The materials, amounts used, proportions, processing details, processing procedures, etc. shown in the following Examples can be changed as appropriate without departing from the spirit of the present invention. Therefore, the scope of the present invention should not be interpreted as being limited by the specific examples shown below.

### Examples 1 to 8

### <Preparation of Hydrophobic Deep Eutectic Solvent>

Metal recovery was performed using the metal recovery apparatus shown in FIG. 1.

First, a solid particulate hydrogen bond donor (HBD) and a solid particulate hydrogen bond acceptor (HBA) were each weighed at 25° C. so as to have a predetermined molar ratio, shaken and mixed well, and then completely dissolved by ultrasonic irradiation in a warm bath to prepare a liquid hydrophobic deep eutectic solvent (DES). The chemical structures of the compounds used are shown below. A hydrophobic deep eutectic solvent was prepared with the compositions of HBTA/TOPO (2:1) and decA/TOPO (1:1) (the molar ratio of HBD:HBA is shown in parentheses).

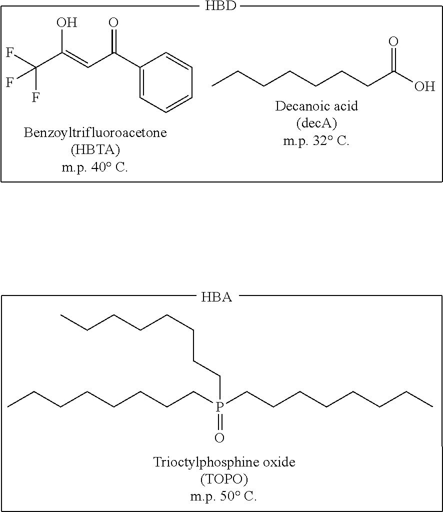

As the metal element-containing composition that is solid at 25° C., LiCoO₂ (LCO), which is solid at 25° C., was used. In the leaching of LiCoO₂, which is a typical positive electrode active material of lithium ion batteries (LiB), reduction of Co(III) to Co(II) is effective in improving the leaching efficiency. In order to leach LCO into a hydrophobic deep eutectic solvent with high efficiency, (a) L-ascorbic acid (ascA), (b) citric acid (citricA), or (c) malic acid (malicA) was used as a reducing agent. The molecular structure of the reducing agent used is shown below.

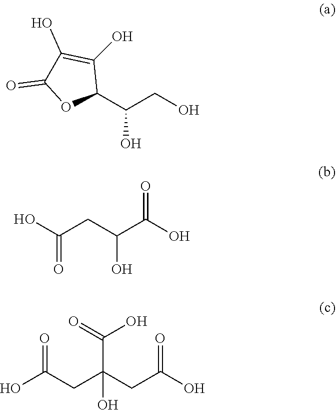 [SMILES: O=C1O[C@H]([C@@H](O)CO)C(O)=C1O ; O=C(O)CC(O)C(=O)O ; O=C(O)CC(O)(CC(=O)O)C(=O)O]

In Example 1, HBTA/TOPO (2:1) to which no reducing agent was added was used as the hydrophobic deep eutectic solvent.

In Examples 2 to 4, ascA, citricA, or malicA was dissolved as a reducing agent in HBTA/TOPO (2:1) to a predetermined concentration of 0.1 mol dm⁻³, and a predetermined amount of pure water was added and stirred at 60° C. and 400 rpm for 1 hour to obtain a homogeneous solution, which was used as the hydrophobic deep eutectic solvent.

In Example 5, decA/TOPO (1:1) to which no reducing agent was added was used as the hydrophobic deep eutectic solvent.

In Examples 6 to 8, ascA, citricA, or malicA was dissolved as a reducing agent in decA/TOPO (1:1) to a predetermined concentration of 0.1 mol dm⁻³. A predetermined amount of pure water was added, and the mixture was stirred at 60° C. and 400 rpm for 1 hour to obtain a homogeneous solution, which was used as the hydrophobic deep eutectic solvent.

The water content of the hydrophobic deep eutectic solvent used in each Example was adjusted to 2.5%.

### <Leaching>

To the hydrophobic deep eutectic solvent used in each Example introduced into the leaching unit of the metal recovery apparatus, LiCoO₂ was added as a metal element-containing composition such that the pulp concentration was 10 g/L. The mixture was stirred at 60° C. and 400 rpm to start leaching reaction, and leaching was carried out for 24 hours.

<Recovery of Li and Co from Deep Eutectic Solvent after Leaching>

As the hydrophilic solvent used in the recovery unit, an oxalic acid aqueous solution was prepared by adding oxalic acid as a chelating agent to pure water.

The hydrophobic deep eutectic solvent from which LiCoO₂ had been leached was brought into contact with the oxalic acid solution of a predetermined concentration at a volume ratio of 1:1, and the mixture was vigorously stirred by vortexing at room temperature for 3 hours. By centrifuging the reaction solution, the mixture was completely separated into a deep eutectic solvent phase (DES phase), an aqueous phase, and a precipitate.

The metal concentration in the aqueous phase and the deep eutectic solvent phase was measured by ICP-OES, and the abundance ratio of each metal in the aqueous phase, the deep eutectic solvent phase, and the precipitate was calculated by mass balance. As a result, it was found that the metal components were successfully separated and recovered one by one.

### [Evaluation]

### <Leaching Efficiency at the Leaching Unit>

The leaching behavior of LCO was investigated using the hydrophobic deep eutectic solvents prepared in Examples 1 to 8 as leaching media.

The leaching rate % L was calculated using the following formula.

$$\% L = \frac{{C}_{M , DES} \times {V}_{DES}}{\frac{{m}_{init}}{97.87}} \times 100$$

Here, % L is the leaching rate, C_{M,DES} is the concentration [mg dm⁻³] of the metal components in the deep eutectic solvent determined from ICP-OES, V_{DES} is the volume [dm⁻³] of the deep eutectic solvent used in the leaching step, mᵤₙᵢₜ is the weighed weight [mg] of the metal element-containing composition, and 97.87 is the molecular weight (formula weight) of LiCoO₂, which is the metal element-containing composition.

Direct quantification of metal concentration in the hydrophobic deep eutectic solvent using an ICP optical emission spectrometer (ICP-OES) was performed using a combination of a matrix matching method and an internal standard method using Y as an internal standard. The solution was prepared as a 20% water/ethanol solution containing 2 ppm of Y and 0.2 mol dm⁻³ of HCl, and the DES was diluted 100 times to prepare an ICP-OES measurement sample. The injector was replaced with an injector having an inner diameter of 1 mm, and a cooling chamber was used under strong cooling conditions. Plasma conditions for ICP-OES were plasma gas 10 L/min, auxiliary gas 0 L/min, and nebulizer gas 0.5 L/min, and other conditions were default settings. The correlation coefficient of the calibration curve obtained under these conditions was R>0.9995, and good linearity was obtained.

The obtained results are shown in FIG. 4.

From FIG. 4, it was found that in Examples 1 to 8, the metal components contained in the metal element-containing compositions were successfully directly leached into the hydrophobic deep eutectic solvent.

HBTA/TOPO (2:1) in Examples 1 to 4 showed higher leaching efficiency than decA/TOPO (1:1) in Examples 5 to 8 for all types of reducing agents. The high leaching efficiency of HBTA/TOPO (2:1) is believed to be due to its higher coordination ability than that of decA/TOPO (1:1).

In Example 2, high leaching efficiency of 90% or more for both Li and Co was achieved by adding ascA as a reducing agent to HBTA/TOPO (2:1).

On the other hand, when comparing the systems of Examples 2 and 6 using ascA as the reducing agent, the systems of Examples 3, 4, 7, and 8 using citricA or malicA as the reducing agent, and the systems of Examples 1 and 5 without adding a reducing agent, the systems of Examples 3, 4, 7, and 8 using citricA or malicA as the reducing agent showed the lowest leaching efficiency.

### Examples 11 to 14

### <Preparation of Hydrophobic Deep Eutectic Solvent>

The effect of ascA concentration on LCO leaching into HBTA/TOPO (2:1) was investigated.

In Examples 11 to 14, ascA was dissolved as a reducing agent in HBTA/TOPO (2:1) to concentrations of 0.05 mol dm⁻³, 0.10 mol dm⁻³, 0.15 mol dm⁻³, and 0.20 mol dm⁻³. A predetermined amount of pure water was added, and the mixture was stirred at 60° C. and 400 rpm for 1 hour to obtain a homogeneous solution, which was used as the hydrophobic deep eutectic solvent.

The water content of the hydrophobic deep eutectic solvent used in each Example was adjusted to 2.5%.

### <Leaching>

To the hydrophobic deep eutectic solvent used in each Example introduced into the leaching unit of the metal recovery apparatus, LiCoO₂ was added as a metal element-containing composition such that the pulp concentration was 10 g/L. The mixture was stirred at 60° C. and 400 rpm to start leaching reaction, and leaching was carried out for 3 hours.

<Recovery of Li and Co from Deep Eutectic Solvent after Leaching>

As the hydrophilic solvent used in the recovery unit, an oxalic acid aqueous solution was prepared by adding oxalic acid as a chelating agent to pure water.

The hydrophobic deep eutectic solvent from which LiCoO₂ had been leached was brought into contact with the oxalic acid aqueous solution of a predetermined concentration at a volume ratio of 1:1, and the mixture was vigorously stirred by vortexing at room temperature for 3 hours. By centrifuging the reaction solution, the mixture was completely separated into a deep eutectic solvent phase (DES phase), an aqueous phase, and a precipitate.

The metal concentration in the aqueous phase and the deep eutectic solvent phase was measured by ICP-OES, and the abundance ratio of each metal in the aqueous phase, the deep eutectic solvent phase, and the precipitate was calculated by mass balance. As a result, it was found that the metal components were successfully separated and recovered one by one.

### [Evaluation]

### <Leaching Efficiency at the Leach Unit>

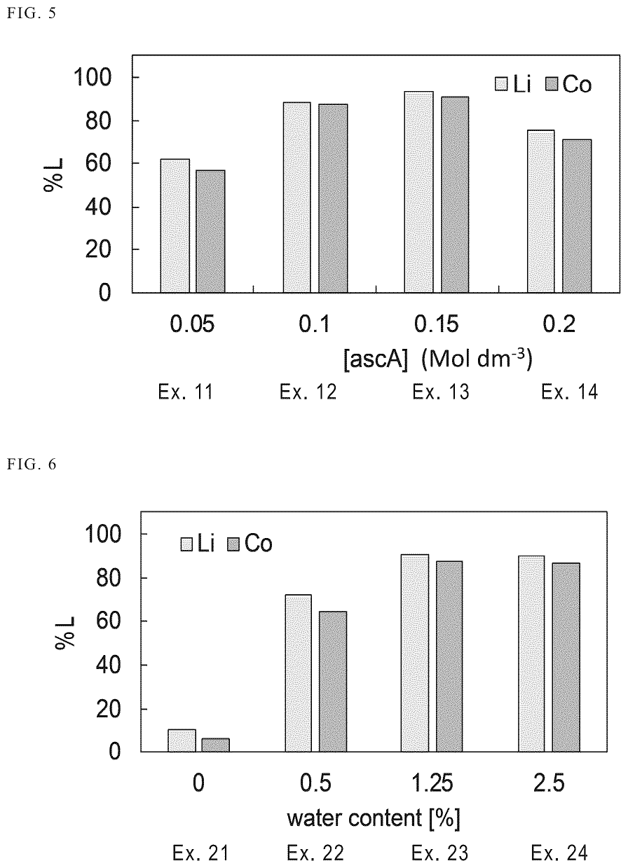

Using the same method as in Examples 1 to 8, the leaching rate % L in Examples 11 to 14 was determined and the leaching efficiency at the leaching unit was determined. The obtained results are shown in FIG. 5.

From FIG. 5, it was found that in Examples 11 to 14, the metal components contained in the metal element-containing compositions were successfully directly leached into the hydrophobic deep eutectic solvent.

From Examples 11 to 13, when the ascA concentration in HBTA/TOPO (2:1) was in the range of 0.05 to 015 mol dm⁻³, the leaching efficiency increased as the ascA concentration increased, and the leaching efficiency of LiCoO₂ was maximum when [ascA]=0.15 mol dm⁻³. Under conditions where the pulp density of LiCoO₂ is 10 g/L (10 g dm⁻³), about 0.1 mol dm³ of Co(III) was present, suggesting that one equivalent or more of a reducing agent is required for its reduction.

On the other hand, as shown in Example 14, when ascA reached a higher concentration of 0.20 mol dm⁻³, the leaching efficiency was lower than in Examples 12 and 13. This is considered to be due to excess ascA adhering to the surface of the LiCoO₂ powder during the reaction and inhibiting leaching.

### Examples 21 to 24

### <Preparation of Hydrophobic Deep Eutectic Solvent>

The effect of water content on LCO leaching into a hydrophobic deep eutectic solvent containing HBTA/TOPO (2:1) and a reducing agent AscA was investigated. In Example 21, ascA was dissolved as a reducing agent in HBTA/TOPO (2:1) to a concentration of 0.10 mol dm⁻³, and without adding pure water, the mixture was stirred at 60° C. and 400 rpm for 1 hour to obtain a homogeneous solution. The one with a water content of 0% was used as the hydrophobic deep eutectic solvent.

In Examples 22 to 24, ascA was dissolved as a reducing agent in HBTA/TOPO (2:1) to a concentration of 0.10 mol dm⁻³. A predetermined amount of pure water was added, and the mixture was stirred at 60° C. and 400 rpm for 1 hour to obtain a homogeneous solution. The ones with water contents of 0.5%, 1.25%, and 2.5% were used as the hydrophobic deep eutectic solvents.

### <Leaching>

To the hydrophobic deep eutectic solvent used in each Example introduced into the leaching unit of the metal recovery apparatus, LiCoO₂ was added as a metal element-containing composition such that the pulp concentration was 10 g/L. The mixture was stirred at 60° C. and 400 rpm to start leaching reaction, and leaching was carried out for 3 hours.

<Recovery of Li and Co from Deep Eutectic Solvent after Leaching>

As the hydrophilic solvent used in the recovery unit, an oxalic acid aqueous solution was prepared by adding oxalic acid as a chelating agent to pure water.

The hydrophobic deep eutectic solvent from which LiCoO₂ had been leached was brought into contact with the oxalic acid aqueous solution of a predetermined concentration at a volume ratio of 1:1, and the mixture was vigorously stirred by vortexing at room temperature for 3 hours. By centrifuging the reaction solution, the mixture was completely separated into a deep eutectic solvent phase (DES phase), an aqueous phase, and a precipitate.

The metal concentration in the aqueous phase and the deep eutectic solvent phase was measured by ICP-OES, and the abundance ratio of each metal in the aqueous phase, the deep eutectic solvent phase, and the precipitate was calculated by mass balance. As a result, it was found that the metal components were successfully separated and recovered one by one.

### [Evaluation]

### <Leaching Efficiency at the Leach Unit>

Using the same method as in Examples 1 to 8, the leaching rate % L in Examples 21 to 24 was determined and the leaching efficiency at the leaching unit was determined.

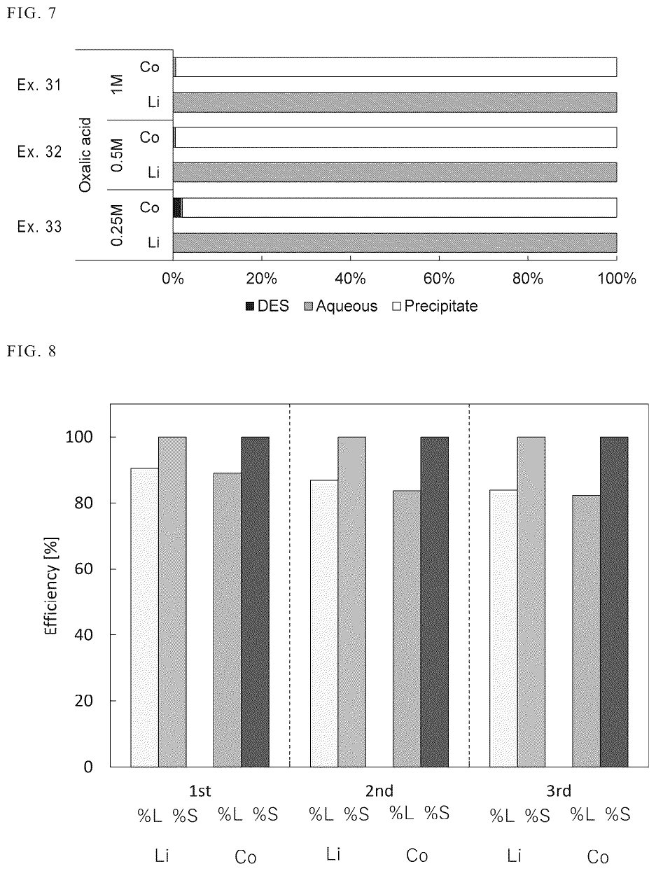

The obtained results are shown in FIG. 6.

From FIG. 6, it was found that in Examples 21 to 24, the metal components contained in the metal element-containing compositions were successfully directly leached into the hydrophobic deep eutectic solvent.

From Example 21, it was found that even though ascA was added as a reducing agent, both Li and Co showed extremely low leaching efficiency under conditions where no water was added.

From Examples 22 to 24, the leaching efficiency of Li and Co improved dramatically as the water content increased. This suggested that the presence of water molecules was involved in the reduction of Co(III) to Co(II) by ascA. Dehydroascorbic acid (DHA), an oxidation product of ascA, is chemically unstable and produces an end product such as L-threonic acid and oxalic acid through hydrolysis and further oxidation reactions. It is believed that the added water is consumed in the hydrolysis reaction to produce a stable ascA oxidation product in the hydrophobic deep eutectic solvent.

### Examples 31 to 33

### <Preparation of Hydrophobic Deep Eutectic Solvent>

The effect of the type of hydrophilic solvent used in the recovery unit was investigated.

In Examples 31 to 33, ascA was dissolved as a reducing agent in HBTA/TOPO (2:1) to a concentration of 0.10 mol dm⁻³. A predetermined amount of pure water was added, and the mixture was stirred at 60° C. and 400 rpm for 1 hour to obtain a homogeneous solution. The one with a water content of 2.5% was used as the hydrophobic deep eutectic solvent.

### <Leaching>

To the hydrophobic deep eutectic solvent used in each Example introduced into the leaching unit of the metal recovery apparatus, LiCoO₂ was added as a metal element-containing composition such that the pulp concentration was 10 g/L. The mixture was stirred at 60° C. and 400 rpm to start leaching reaction, and leaching was carried out for 3 hours.

<Recovery of Li and Co from Deep Eutectic Solvent after Leaching>

As the hydrophilic solvent used in the recovery unit, an oxalic acid aqueous solution was prepared by adding oxalic acid as a chelating agent to pure water. The hydrophobic deep eutectic solvent from which LiCoO₂ had been leached was brought into contact with the oxalic acid aqueous solution of a predetermined concentration at a volume ratio of 1:1, and the mixture was vigorously stirred by vortexing at room temperature for 3 hours. By centrifuging the reaction solution, the mixture was completely separated into a deep eutectic solvent phase (DES phase), an aqueous phase, and a precipitate. The oxalic acid reacts with Co(II) to produce a pink precipitate of poorly soluble Co(C₂O₄)·2H₂O. Further, since HBTA/TOPO (2:1) shows pH-dependent extraction curve for Li and Co, both metals are recovered, that is, reverse-extracted, into the aqueous phase which is acidic with oxalic acid.

In Examples 31 to 33, the concentrations of the oxalic acid aqueous solutions were 1.00 M, 0.50 M, and 0.25 M (mol dm⁻³), respectively.

The metal concentration in the aqueous phase and the deep eutectic solvent phase was measured by ICP-OES, and the abundance ratio of each metal in the aqueous phase (Aqueous), the deep eutectic solvent phase (DES), and the precipitate (Precipitate) was calculated by mass balance. The results are shown in FIG. 7.

From FIG. 7, it was found that the metal components were successfully separated and recovered one by one in Examples 31 to 33. Specifically, Li was quantitatively recovered in the aqueous phase at all oxalic acid concentrations. In particular, 99% of Co was precipitated and recovered as oxalate when the oxalic acid concentration of Examples 32 and 33 was 0.5 mol dm⁻³ or more. That is, in Examples 32 and 33, the recovery rate and purity of each metal component were both found to be 99% or more. Therefore, it was suggested that both Li and Co can be quantitatively removed from the deep eutectic solvent by using an oxalic acid aqueous solution, and that the deep eutectic solvent can be completely regenerated.

### <Preparation of Hydrophobic Deep Eutectic Solvent>

The reusability of the type of the deep eutectic solvent was investigated by repeating the leaching and recovery (reverse extraction) of LCO with HBTA/TOPO (2:1).

In Example 41, ascA was dissolved as a reducing agent in HBTA/TOPO (2:1) to a concentration of 10 mol dm⁻³. A predetermined amount of pure water was added, and the mixture was stirred at 60° C. and 400 rpm for 1 hour to obtain a homogeneous solution. The one prepared with a water content of 2.5% was used as the hydrophobic deep eutectic solvent.

### <Leaching>

To the hydrophobic deep eutectic solvent introduced into the leaching unit of the metal recovery apparatus, LiCoO₂ was added as a metal element-containing composition such that the pulp concentration was 10 g/L. The mixture was stirred at 60° C. and 400 rpm to start leaching reaction, and leaching was carried out for 3 hours.

<Recovery of Li and Co from Deep Eutectic Solvent after Leaching>

As the hydrophilic solvent used in the recovery unit, an oxalic acid aqueous solution was prepared by adding oxalic acid as a chelating agent to pure water.

The hydrophobic deep eutectic solvent from which LiCoO₂ had been leached was brought into contact with 0.50 mol dm⁻³ of an oxalic acid aqueous solution at a volume ratio of 1:1, and the mixture was vigorously stirred by vortexing at room temperature for 3 hours. By centrifuging the reaction solution, the mixture was completely separated into a deep eutectic solvent phase (DES phase), an aqueous phase, and a precipitate.

The metal concentration in the aqueous phase and the deep eutectic solvent phase was measured by ICP-OES, and the abundance ratio of each metal in the aqueous phase, the deep eutectic solvent phase, and the precipitate was calculated by mass balance. As a result, it was found that Co and Li components were successfully completely recovered from the deep eutectic solvent phase (DES phase).

<Recycle of Deep Eutectic Solvent from which Metal Components have been Separated>

The deep eutectic solvent from which the metal components had been separated was moved to the recycle unit, and washed with 1 mol dm⁻³ of ammonia water and pure water (MilliQ) for 30 minutes each as a washing step.

Thereafter, the deep eutectic solvent after washing was moved from the recycle unit to the leaching unit and used for leaching in a next cycle.

A total of three cycles of the above leaching, recovery, and recycle were performed.

### [Evaluation]

### <Leaching Efficiency and Recovery Efficiency Using Recycled Deep Eutectic Solvent>

The Co and Li concentrations in the deep eutectic solvent in each cycle were measured by ICP-OES, and the leaching rate % L and the recovery rate % S were examined. Using the same method as in Example 1, the leaching rate % L of Co and Li in each cycle of Example 41 was determined and the leaching efficiency at the leaching unit was determined.

The recovery rate % S of Co and Li in each cycle indicates the removal rate of each metal component from the deep eutectic solvent. The recovery rate % S was determined from the following Formula 2.

$$\% S = \frac{{C}_{M , S , DES} \times {V}_{S , DES}}{{C}_{M , L , DES} \times {V}_{L , DES}} \times 100$$

In the formula 2, % S represents the recovery rate, C_{M,S,DES} represents the concentration of the metal component in the deep eutectic solvent in the recovery step, V_{S,DES} represents the volume of the deep eutectic solvent in the recovery step, C_{M,I,DES} represents the concentration of the metal component in the deep eutectic solvent in the leaching step, and V_{L,DES} represents the volume of the deep eutectic solvent in the leaching step.

The obtained results are shown in FIG. 8.

From FIG. 8, it was found that the metal components were successfully separated and recovered one by one in all of the first cycle (1st), second cycle (2nd), and third cycle (3rd). Specifically, the leaching efficiency of Li and Co decreased slightly with repeated cycles. The recovery (reverse extraction) of Li and Co using the oxalic acid aqueous solution was approximately 100%, respectively. From the above results, it was found that the deep eutectic solvent can be reused as a leaching solvent for LCO.

A small amount of oxalic acid was dissolved in the DES that came into contact with the oxalic acid aqueous solution, which was expected to be a factor inhibiting the leaching of LCO. However, it was found that by performing the washing step in the recycle unit, the leaching efficiency and recovery efficiency in the second and third cycles could be sufficiently increased, making it easier to recycle the deep eutectic solvent.

### Example 42

In the preparation and leaching of the hydrophobic deep eutectic solvent of Example 41, the solid particulate hydrogen bond donor (HBD) and hydrogen bond acceptor (HBA) were each weighed and not mixed, and the metal recovery was carried out in the same manner as in Example 41 except that the solid particulate hydrogen bond donor and hydrogen bond acceptor were sprinkled on and brought into direct contact with LiCoO₂, which is a metal element-containing composition, in the leaching unit.

As a result, it was found that the evaluation results were equivalent to those of Example 41.

### Examples 51 and 52

### <Preparation of Hydrophobic Deep Eutectic Solvent>

The leaching and recovery of various anolytes with HBTA/TOPO (2:1) were investigated.

In Examples 51 and 52, ascA was dissolved as a reducing agent in HBTA/TOPO (2:1) to a concentration of 10 mol dm³. A predetermined amount of pure water was added, and the mixture was stirred at 60° C. and 400 rpm for 1 hour to obtain a homogeneous solution. The one prepared with a water content of 2.5% was used as the hydrophobic deep eutectic solvent.

### <Leaching>

In Example 51, to the hydrophobic deep eutectic solvent introduced into the leaching unit of the metal recovery apparatus, commercially available LiNi_{1/3}Mn_{1/3}Co_{1/3}O₂ (NMC111) was added as a metal element-containing composition such that the pulp concentration was 10 g/L. The mixture was stirred at 60° C. and 400 rpm to start the leaching reaction, and the leaching was carried out for 3 hours. NMC111 is a model compound for next-generation lithium ion battery anode material, and is solid at 25° C.

In Example 52, the leaching was carried out in the same manner as in Example 51, except that a used lithium ion battery anode material (spent cathode) was used as the metal element-containing composition. The used lithium ion battery anode material (spent cathode) is a positive electrode material for automotive lithium ion batteries, is a mixture of anode material powders recovered from various sources, and is solid at 25° C.

<Recovery of Metal from Deep Eutectic Solvent after Leaching>

As the hydrophilic solvent used in the recovery unit, an oxalic acid aqueous solution was prepared by adding oxalic acid as a chelating agent to pure water.

The hydrophobic deep eutectic solvent from which the positive electrode material had been leached was brought into contact with 0.50 mol dm⁻³ of an oxalic acid aqueous solution at a volume ratio of 1:1, and the mixture was vigorously stirred by vortexing at room temperature for 3 hours. By centrifuging the reaction solution, the mixture was completely separated into a deep eutectic solvent phase (DES phase), an aqueous phase, and a precipitate.

The metal concentration in the aqueous phase and the deep eutectic solvent phase was measured by ICP-OES, and the abundance ratio of each metal in the aqueous phase, the deep eutectic solvent phase, and the precipitate was calculated by mass balance.

### [Evaluation]

### <Leaching Efficiency and Recovery Efficiency>

The leaching rate % L and the recovery rate % S were calculated using the following formulas.

$$\% L = \frac{{C}_{M , L , DES} \times {V}_{L , DES}}{{m}_{init} \times {R}_{M}} \times 100$$

$$\% S = \frac{{C}_{M , S , DES} \times {V}_{S , DES}}{{C}_{M , L , DES} \times {V}_{L , DES}} \times 100$$

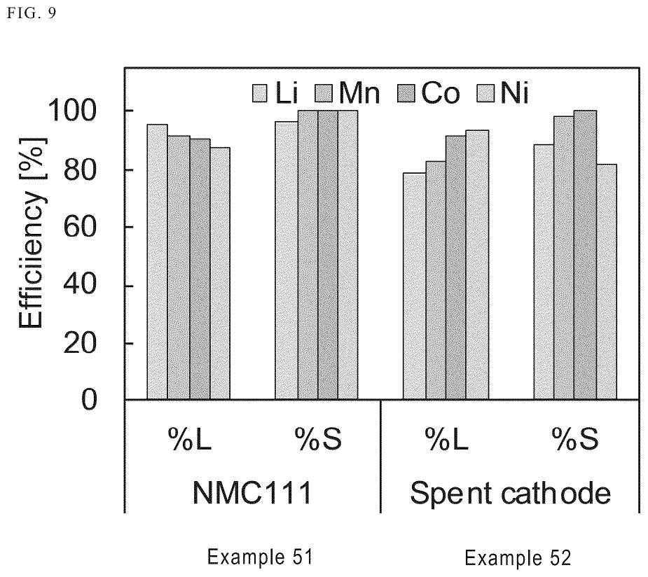

In each formula, % L is the leaching rate, % S is the recovery rate, C_{M,DES} is a measured value [mg dm⁻³] of the metal concentration in DES determined from ICP-OES, V_{DES} is the vohume [dm⁻³] the deep eutectic solvent used in leaching, mᵤₙᵢₜ is the weight [mg] of the positive electrode material, and Rat is the weight ratio [-] of the metal M in the positive electrode material. Subscripts L and S indicate leaching and recovery operations. The obtained results are shown in FIG. 9. In FIG. 9, the bar graphs each consisting of a set of four series of % L and % S represent the series of Li, Mn, Co, and Ni in order from the left.

From FIG. 9, it was found that in Examples 51 and 52, the metal components were at least successfully separated and recovered one by one. Specifically, it was found that the metal components were successfully leached with high efficiency from the positive electrode materials of both NMC111 and Spent cathode. In addition, it was found that by bringing the oxalic acid solution into contact with the deep eutectic solvent after leaching in the recovery unit, Li was separated and recovered as an aqueous solution, and Ni, Mn, and Co were recovered as a mixed oxalate.

<Comparison of Positive Electrode Material Residues after Leaching>

As Comparative Example 53, leaching of soluble metals using 5M HCl and 5% by mass of H₂O₂ was performed on a positive electrode material (Spent cathode) similar to the positive electrode material used in Example 52.

Differences between Comparative Example 53 and the positive electrode material (residue) after leaching with a deep eutectic solvent in Example 52 were compared in terms of morphology and elemental analysis.

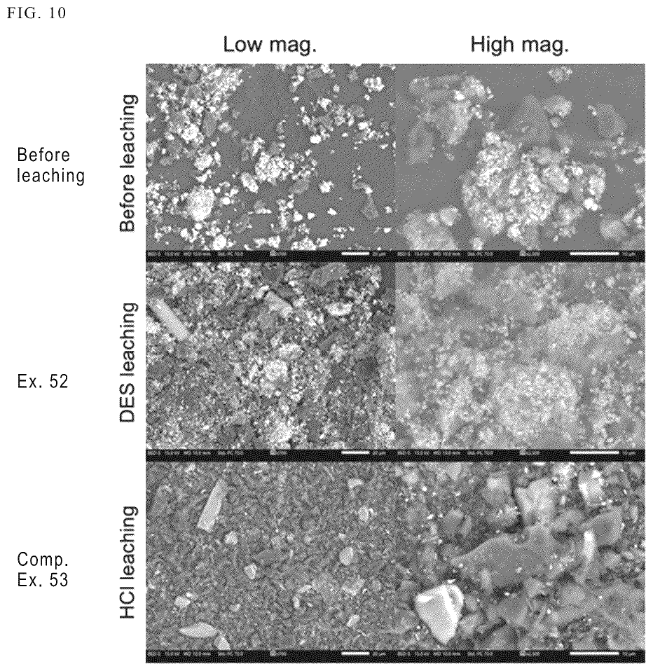

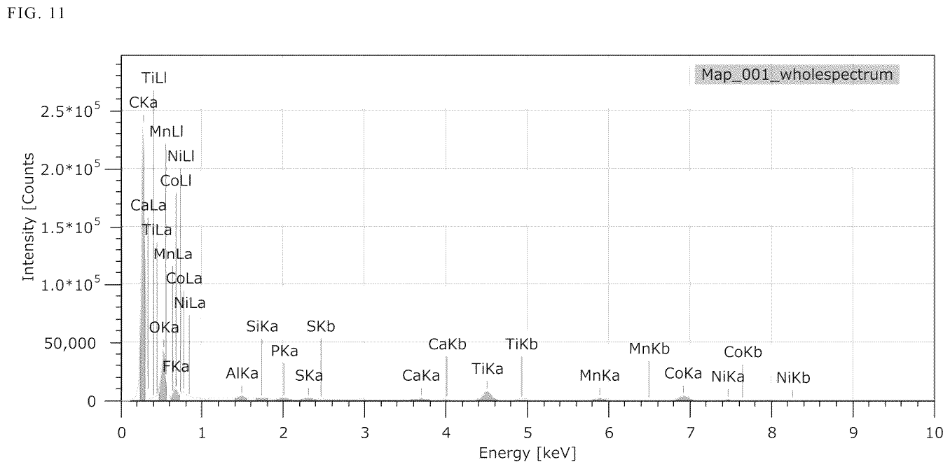

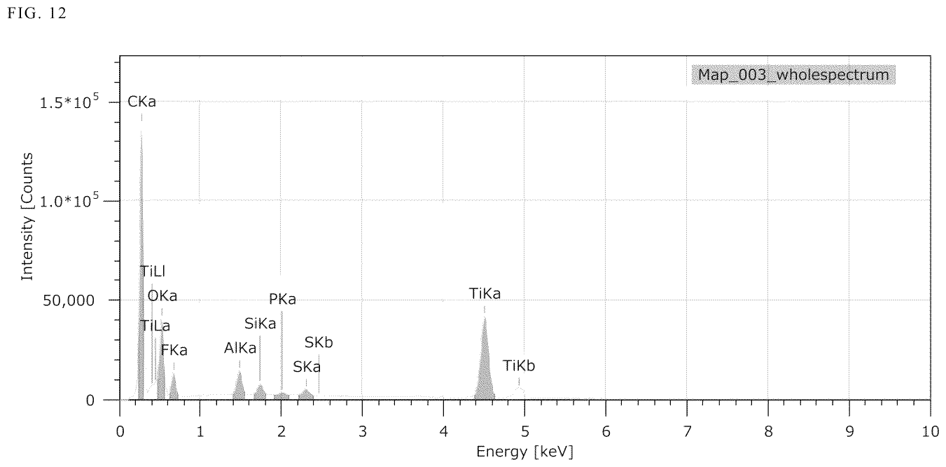

FIG. 10 shows electron micrographs of the positive electrode material before leaching, the positive electrode material after leaching of Example 52, and the positive electrode material after leaching of Comparative Example 53, observed with a scanning electron microscope equipped with an X-ray spectrometer (SEM-EDS). In FIG. 10, High mag. is a photograph taken in a high-magnification mode (High-mag mode), and Low-mag. is a photograph taken in a low-magnification mode (Low-mag mode).

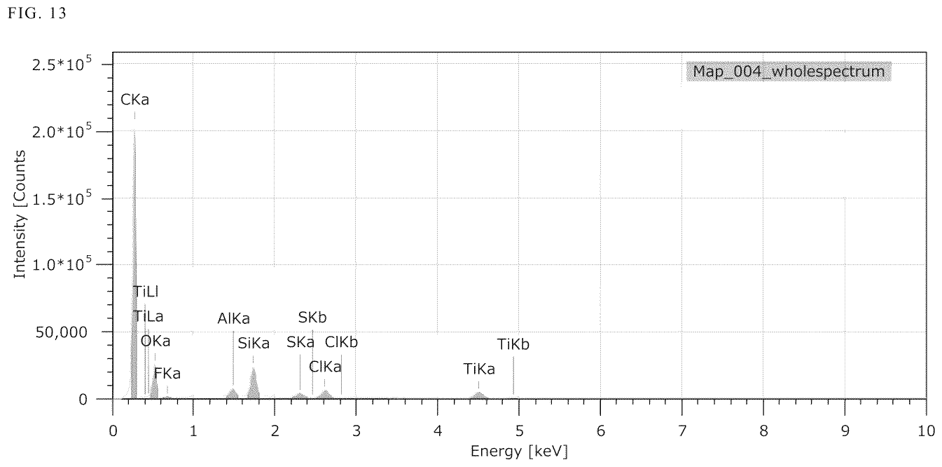

FIGS. 11 to 13 each show an EDS chart obtained by performing elemental analysis using an energy dispersive X-ray spectrometer (EDS) on the positive electrode material before leaching, the positive electrode material after leaching of Example 52, and the positive electrode material after leaching of Comparative Example 53.

From FIGS. 11 to 13, it was found that the positive electrode materials used in Example 52 and Comparative Example 53 contained Al, Si, Ti, etc. in addition to the active materials Co and Mn oxides. After leaching with the deep eutectic solvent of Example 52, the EDS results show that Al, Si, and Ti remain in the residue. On the other hand, after leaching with HCl in Comparative Example 53, the peaks of Al and Ti became smaller, suggesting that these metals were leached into the acid solution at the same time as the rare metals (Co and Mn).

Therefore, it was shown that the metal recovery method of the present invention, metal leaching and recovery using a hydrophobic deep eutectic solvent, is more efficient and selective than conventional methods, and has high industrial applicability.

### Example 61

Metal recovery from ore (limonite/saprolite) was investigated using the metal recovery apparatus shown in FIG. 14.

As a reducing agent, ascA was dissolved in HBTA/TOPO (2:1) to a concentration of 0.1 mol dm⁻³. A predetermined amount of pure water was added, and the mixture was stirred at 60° C. and 400 rpm for 1 hour to obtain a homogeneous solution. The one prepared with a water content of 2.5% was used as the hydrophobic deep eutectic solvent.

### <Leaching>

To the hydrophobic deep eutectic solvent introduced into the leaching unit of the metal recovery apparatus, an ore (limonite/saprolite), which is solid at 25° C., was added as a metal element-containing composition. The mixture was stirred at 60° C. and 400 rpm to start the leaching reaction, and the leaching was carried out for 3 hours. It was found that Fe, Ni, and Co can be selectively leached from the ore.

### <Washing>

To the hydrophobic deep eutectic solvent after the leaching step introduced into the washing unit of the metal recovery apparatus, a hydrophilic solvent supplemented with an appropriate metal scavenger (0.1 to 5 mol dm⁻³ of sodium hydroxide and/or sodium sulfite) was added to precipitate iron impurities in the aqueous phase.

<Recovery of Metal from Deep Eutectic Solvent after Leaching>

As the hydrophilic solvents used in the recovery unit, an oxalic acid aqueous solution prepared by adding oxalic acid as a chelating agent to pure water, and sulfuric acid were prepared.

The hydrophobic deep eutectic solvent from which the positive electrode material had been leached was brought into contact with the oxalic acid aqueous solution and/or the sulfuric acid, and the mixture was vigorously stirred at room temperature. By centrifuging the reaction solution, the mixture was completely separated into a deep eutectic solvent phase (DES phase), an aqueous phase, and a precipitate.

Nickel sulfate, nickel oxalate, cobalt sulfate and/or cobalt oxalate were recovered from the aqueous phase, and then nickel oxide and cobalt oxide were obtained.

<Recycle of Deep Eutectic Solvent from which Metal Components have been Separated>

The deep eutectic solvent from which the metal components had been separated was moved to the recycle unit, and washed with 1 mol dm⁻³ of ammonia water and pure water (MilliQ) each as a washing step.

Thereafter, the deep eutectic solvent after washing was moved from the recycle unit to the leaching unit and used for leaching in the next cycle.

A total of three cycles of the above leaching, recovery, and recycle were performed.

From Example 61, it was found that metal salts can be recovered in each cycle, that the deep eutectic solvent is useful as a leaching solvent for ores (limonite/saprolite) and is reusable.

1. A metal recovery apparatus comprising
a leaching unit that directly leaches at least one metal component contained in a metal element-containing composition into a hydrophobic deep eutectic solvent, and
a recovery unit that separates and recovers the metal component from the deep eutectic solvent, wherein
the metal element-containing composition is solid at 25° C. and does not contain an inorganic acid,
the metal component is a metal, a metal compound, or metal ions, and
the deep eutectic solvent does not contain an inorganic acid.

2. The metal recovery apparatus according to claim 1, wherein the deep eutectic solvent has hydrophobicity of 1 g/100 mL or less in terms of solubility in water at 25° C.

3. The metal recovery apparatus according to claim 1, wherein the deep eutectic solvent does not contain an organic solvent having a boiling point of 150° C. or lower alone.

4. The metal recovery apparatus according to claim 1, wherein extraction of moving the metal component from the deep eutectic solvent to another organic solvent is not performed between the leaching unit and the recovery unit.

5. The metal recovery apparatus according to claim 1, wherein the deep eutectic solvent is a liquid at 25° C.

6. The metal recovery apparatus according to claim 1, wherein the metal element-containing composition contains two or more types of the metal components,
the deep eutectic solvent selectively leaches a specific type of metal component among the two or more types of metal components at a higher concentration than other types of metal components.

7. The metal recovery apparatus according to claim 1, wherein the deep eutectic solvent is a mixture of a hydrogen bond donor and a hydrogen bond acceptor,
at 25° C., the hydrogen bond donor and the hydrogen bond acceptor before mixing are in a form of solid particles,
the metal component is brought into contact with the deep eutectic solvent by directly contacting the solid particulate hydrogen bond donor and hydrogen bond acceptor with the metal element-containing composition.

8. The metal recovery apparatus according to claim 1, wherein the deep eutectic solvent is a mixture of a hydrogen bond donor and a hydrogen bond acceptor,
the hydrogen bond donor is benzoyltrifluoroacetone or a decanoic acid, and
the hydrogen bond acceptor is tri-n-octylphosphine oxide.

9. The metal recovery apparatus according to claim 1, wherein the deep eutectic solvent is a mixture of a hydrogen bond donor and a hydrogen bond acceptor,
the hydrogen bond donor has a concentration controlled to be 1.2 to 5 times the concentration of the hydrogen bond acceptor.

10. The metal recovery apparatus according to claim 1, wherein the metal element-containing composition contains a metal oxide, and
a reducing agent is further added to the deep eutectic solvent.

11. The metal recovery apparatus according to claim 10, wherein the reducing agent is an L-ascorbic acid, a citric acid, or a malic acid.

12. The metal recovery apparatus according to claim 10, wherein the reducing agent has a concentration controlled to 0.03 to 0.30 mol/L with respect to the deep eutectic solvent.

13. The metal recovery apparatus according to claim 10, wherein the metal element-containing composition contains LiCoO₂ or LiNi_{1/3}Mn_{1/3}Co_{1/3}O₂.

14. The metal recovery apparatus according to claim 1, wherein the metal element-containing composition contains a platinum group metal or a platinum group metal compound, and
an oxidizing agent is further added to the deep eutectic solvent.

15. The metal recovery apparatus according to claim 1, wherein the deep eutectic solvent has a water content controlled to 0.3 to 2.8% by mass.

16. The metal recovery apparatus according to claim 1, wherein the recovery unit brings a hydrophilic solvent into contact with the deep eutectic solvent to separate and recover the metal component in the hydrophilic solvent.

17. The metal recovery apparatus according to claim 16, wherein a chelating agent is added to the hydrophilic solvent, and the metal component is precipitated as a salt in the hydrophilic solvent to be separated and recovered.

18. The metal recovery apparatus according to claim 1, further including a recycle unit that returns the deep eutectic solvent from which the metal component has been separated in the recovery unit to the leaching unit to recycle.

19. The metal recovery apparatus according to claim 18, wherein the recycle unit cleans the deep eutectic solvent using a cleaning liquid that is capable of removing the chelating agent.

20. The metal recovery apparatus according to claim 18, wherein, when a cycle of the leaching unit, the recovery unit, and the recycle unit is repeated three times using only the deep eutectic solvent returned by the recycle unit in the leaching unit, the metal component has a leaching rate expressed by the following formula 1 of 80% or more, and the metal component has a recovery rate expressed by the following formula 2 of 95% or more,
$$\% L = \frac{{C}_{M , DES} \times {V}_{DES}}{\frac{{m}_{init}}{m}} \times 100 \qquad Formula 1$$
in the formula 1, % L represents the leaching rate, C_{M,DES} represents a concentration of the metal component in the deep eutectic solvent, V_{DES} represents a volume of the deep eutectic solvent, mᵢₙᵢₜ represents a mass of the metal element-containing composition, and m represents a molecular weight of the metal element-containing composition,
$$\% S = \frac{{C}_{M , S , DES} \times {V}_{S , DES}}{{C}_{M , L , DES} \times {V}_{L , DES}} \times 100 \qquad Formula 2$$
in the formula 2, % S represents the recovery rate, C_{M,S,DES} represents the concentration of the metal component in the deep eutectic solvent in a recovery step, V_{S,DES} represents the volume of the deep eutectic solvent in the recovery step, C_{M,L,DES} represents the concentration of the metal component in the deep eutectic solvent in a leaching step, and V_{L,DES} represents the volume of the deep eutectic solvent in the leaching step.

21. A metal recovery method, comprising
directly leaching at least one metal component contained in a metal element-containing composition into a hydrophobic deep eutectic solvent, and
separating and recovering the metal component from the deep eutectic solvent, wherein
the metal element-containing composition is solid at 25° C. and does not contain an inorganic acid,
the metal component is a metal, a metal compound, or metal ions, and
the deep eutectic solvent does not contain an inorganic acid.
